(19) United States
(12) Patent Application Publication
(10) Pub. No.: US 2025/0187445 A1
(43) Pub. Date: Jun. 12, 2025

(54) BRAKING CONTROL APPARATUS AND BRAKING CONTROL METHOD

(71) Applicants: HYUNDAI MOTOR COMPANY, Seoul (KR); KIA CORPORATION, Seoul (KR)

(72) Inventor: Dong Wook KIM, Seoul (KR)

(73) Assignees: HYUNDAI MOTOR COMPANY, Seoul (KR); KIA CORPORATION, Seoul (KR)

(21) Appl. No.: 18/618,215

(22) Filed: Mar. 27, 2024

(30) Foreign Application Priority Data
Dec. 8, 2023 (KR) 10-2023-0177454

(51) Int. Cl. B60L 7/10; B60L 15/20

(52) U.S. Cl. CPC B60L 7/10; B60L 15/2009; B60L 2240/12

(57) ABSTRACT

A braking control apparatus includes a first receiving unit detecting internal driving data of a vehicle, a second receiving unit detecting external driving data of the vehicle, a regenerative braking unit generating regenerative braking force, a main braking unit generating braking force in the vehicle, a parking brake unit generating parking brake force in the vehicle, and a controller generating braking force by controlling at least one of the regenerative braking unit, the main braking unit, or the parking brake unit based on the internal driving data and the external driving data in response to determining that unintended acceleration occurs.

### CROSS-REFERENCE TO RELATED APPLICATION(S)

The present application claims the benefit of priority to Korean Patent Application No. 10-2023-0177454, filed on Dec. 8, 2023 in the Korean Intellectual Property Office, the entire disclosure of which is incorporated herein by reference.

### TECHNICAL FIELD

The present disclosure relates to a braking control apparatus and a braking control method.

### BACKGROUND

Electric vehicles accelerate by generating driving force using a driving motor. Therefore, unlike vehicles that use internal combustion engines, such as engines, electric vehicles generate maximum torque even at low RPM, so they exhibit excellent acceleration performance immediately after starting in a stationary state.

If an electric vehicle increases motor output to the maximum while being stationary, the electric vehicle may accelerate at a very high speed.

In other words, if unintended acceleration occurs in an electric vehicle due to the driver's inexperience in operation or the like, it may be difficult for the driver to control the vehicle, and there is a risk that the unintended acceleration may lead to a traffic accident, such as a collision with surrounding obstacles.

The information disclosed in the Background section above is to aid in the understanding of the background of the present disclosure, and should not be taken as acknowledgement that this information forms any part of prior art.

### SUMMARY

An aspect of the present disclosure is to provide a braking control apparatus and a braking control method capable of controlling braking in a vehicle in which unintended acceleration of the driver occurs due to the driver's inexperience in vehicle operation or the like.

According to an aspect of the present disclosure, a braking control apparatus includes: a first receiving unit detecting internal driving data of a vehicle; a second receiving unit detecting external driving data of the vehicle; a regenerative braking unit generating regenerative braking force; a main braking unit generating braking force in the vehicle; a parking brake unit generating parking brake force in the vehicle; and a controller generating braking force by controlling at least one of the regenerative braking unit, the main braking unit, or the parking brake unit based on the internal driving data and the external driving data in response to determining that unintended acceleration occurs.

The internal driving data may include at least one of a driving speed of the vehicle, a transmission status, or an output of a driving motor.

The external driving data may include at least one of whether an obstacle is present in a driving direction of the vehicle, a relative distance between the vehicle and an obstacle in front of the vehicle, location information of the obstacle in front of the vehicle, a traffic signal, a road condition, ongoing construction work, information on adjacent vehicles, whether a road on which the vehicle is driving is a child protection zone, whether the road is a two-lane road, or whether the road is an alley.

The internal driving data may include output of a driving motor, and the controller may compare the output of the driving motor with a preset first reference output or a preset second reference output and generate braking force by controlling at least one of the regenerative braking unit, the main braking unit, or the parking brake unit.

The first reference output may be set to be less than the second reference output.

In response to the output of the driving motor being less than the first reference output, the controller may generate braking force by controlling the regenerative braking unit or the parking brake unit.

In response to the output of the driving motor being greater than the first reference output and less than the second reference output, the controller may generate braking force by controlling the regenerative braking unit, the parking brake unit, and the main braking unit.

In response to the output of the driving motor being greater than the second reference output, the controller may generate braking force by controlling the regenerative braking unit, the parking brake unit, and the main braking unit and may stop the driving motor.

The internal driving data may include a driving speed and a gear shift status, and in response to the driving speed being ‘0 (zero)’ and the gear shift status being a state in which a gear shift is in a driving state or a reverse state, the controller may generate braking force by controlling at least one of the regenerative braking unit, the main braking unit, or the parking brake unit based on the internal driving data and the external driving data.

According to another aspect of the present disclosure, a braking control method includes: receiving internal driving data of a vehicle; receiving external driving data of the vehicle; and in response to determining that unintended acceleration occurs, determining a risk level of the vehicle based on the internal driving data and the external driving data and performing braking based on the risk level.

The internal driving data of the vehicle may include a driving speed and gear shift status information, and receiving of the internal driving data of the vehicle may include determining the received driving speed and the gear shift status.

The determining of the driving speed and the gear shift status may include whether the driving speed is ‘0 (zero)’ and whether the gear shift is in a driving state or a reverse state.

The external driving data may include at least one of whether an obstacle is present in a driving direction of the vehicle, a relative distance between the vehicle and an obstacle in front of the vehicle, location information of the obstacle in front of the vehicle, a traffic signal, a road condition, ongoing construction work, information on adjacent vehicles, whether a road on which the vehicle is driving is a child protection zone, whether the road is a two-lane road, or whether the road is an alley.

The internal driving data may further include output of a driving motor, and the determining of the risk level of the vehicle and performing braking based on the risk level may include determining whether the output of the driving motor increases.

In response to determining that the output of the driving motor increases, the determining of the risk level of the vehicle and performing braking based on the risk level may further include comparing the output of the driving motor with a preset first reference output or a preset second reference output, and the first reference output may be less than the second reference output.

In response to the output of the driving motor being less than the first reference output, in the determining of the risk level of the vehicle and performing braking based on the risk level, braking force may be generated by controlling the regenerative braking unit or the parking brake unit.

In response to the output of the driving motor being greater than the first reference output and less than the second reference output, in the determining of the risk level of the vehicle and performing braking based on the risk level, braking force may be generated by controlling the regenerative braking unit, the parking brake unit, and the main braking unit.

In response to the output of the driving motor being greater than the second reference output, in the determining of the risk level of the vehicle and performing braking based on the risk level, braking force may be generated by controlling the regenerative braking unit, the parking brake unit, and the main braking unit, and the driving motor is stopped.

The external driving data may include at least one of information on whether an obstacle is present in the driving direction of the vehicle, whether the road is a two-lane road, and whether the road on which the vehicle is driving is a child protection zone, and in the determining of the risk level of the vehicle and performing braking based on the risk level, braking force may be generated by controlling the regenerative braking unit and the parking brake unit in response to determining that an obstacle is present in the driving direction of the vehicle, the road is a two-lane road, or the road on which the vehicle is driving is a child protection zone.

The external driving data may include at least one of information on whether an obstacle is present in the driving direction of the vehicle, whether the road is a two-lane road, or whether the road on which the vehicle is driving is a child protection zone, and in the determining of the risk level of the vehicle and performing braking based on the risk level, braking force may be generated by controlling the regenerative braking unit in response to determining that no obstacle is present in the driving direction of the vehicle, the road is a four-lane road, and the road on which the vehicle is driving is not a child protection zone.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a block diagram of a braking control apparatus according to an embodiment of the present disclosure;

FIG. 2 is a block diagram of a braking control method according to an embodiment of the present disclosure;

FIG. 3 is a flowchart of a braking control method according to an embodiment of the present disclosure; and

FIG. 4 is a detailed flowchart of the step S1800 of FIG. 3.

### DETAILED DESCRIPTION

While the present disclosure may be modified in various ways and take on various alternative forms, specific embodiments thereof are illustrated in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terminology used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

Hereinafter, preferred embodiments of the present disclosure will be described in detail with reference to the accompanying drawings.

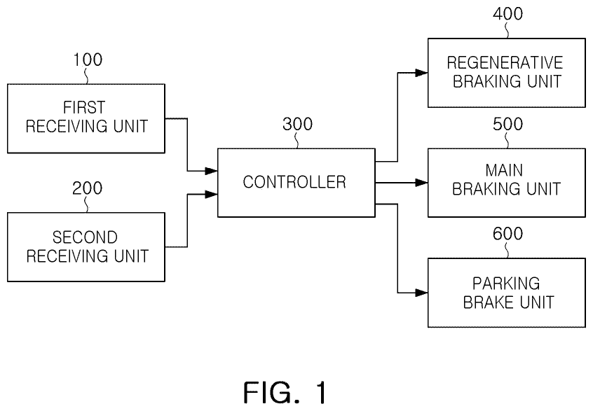

FIG. 1 is a block diagram of a braking control apparatus according to an embodiment of the present disclosure.

The braking control apparatus according to an embodiment of the present disclosure includes a first receiving unit 100, a second receiving unit 200, regenerative braking unit 400, a main braking unit 500, a parking brake unit 600, and a controller 300.

The first receiving unit 100 may receive internal driving data of a vehicle.

The first receiving unit 100 may receive driving data, such as whether the vehicle is stopped, a driving direction of the vehicle, and a current gear status, which are detected sensors, and gear shift through wheel sensors, steering status.

In addition, the first receiving unit 100 may receive torque or output information of a driving device (e.g., a driving motor).

The second receiving unit 200 may receive external driving data of the vehicle using communications units, such as the Internet, LTE, 5G, Wi-Fi, Bluetooth, near field communications (NFC), ZigBee®, and radio frequency (RF).

The second receiving unit 200 may receive obstacle information in front of the vehicle as one piece of the external driving data of the vehicle.

For example, the second receiving unit 200 may receive information on whether an obstacle is present in a driving direction of the vehicle, a relative distance between the vehicle and a front obstacle, or location information of the front obstacle detected through one of radar, light detection and ranging (LIDAR), camera, ultrasonic sensor, and infrared sensor provided in the vehicle.

In addition, the second receiving unit 200 may receive a detailed driving map and driving route information through a global positioning system (GPS) device.

In addition, the second receiving unit 200 may receive information on traffic signals, road conditions, and ongoing construction work using vehicle-to-infrastructure (V2I) communications.

Here, V2I communications refer to communications between vehicles and road infrastructure. Communications equipment may be installed on the road, and the vehicle may receive information through the communications equipment located on the road.

For example, the second receiving unit 200 may receive information on traffic conditions or traffic light conditions by communicating with a traffic control terminal or a traffic light terminal outside the vehicle.

In addition, the second receiving unit 200 may receive information on adjacent vehicles, blind spot information, etc. using vehicle-to-vehicle (V2V) communications.

Here, V2V communications are direct communications between vehicles and may be communications that exchange information using wireless communications technology.

For example, the second receiving unit 200 may receive a location, speed, acceleration, and other driving data of adjacent vehicles using V2V communications with adjacent vehicles.

The first and second receiving units 100 and 200 may be a hardware device implemented by various electronic circuits, e.g., processor, transceiver, etc., to transmit and receive signals via wireless or wired connections.

Here, the controller 300 may process signals transmitted between elements of the braking control apparatus, and in particular may process signals communicated between the controller 300 and first and second receiving units 100 and 200.

The regenerative braking unit 400 may generate regenerative braking force using a driving motor (not shown).

Here, the driving motor may generate driving force necessary for driving the vehicle using electric energy charged in a battery, and driving force generated by the driving motor may be supplied to driving wheels or all wheels of the vehicle so that the vehicle may drive.

During regenerative braking, the driving motor may operate as a power generator to generate electrical energy.

In addition, a plurality of driving motors may be provided in the vehicle. For example, the driving motors may include a front-wheel driving motor and a rear-wheel driving motor. The front-wheel driving motor may supply driving force to two front wheels, and the rear-wheel driving motor may supply driving force to two rear wheels.

The main braking unit 500 may be a device slowing down or stopping the vehicle.

The main braking unit 500 may generate braking force to each wheel. The braking unit may be a hydraulic wheel brake that operates using hydraulic pressure or may be an electro-electronic wheel brake (e.g., electromechanical brake (EMB)) that operates using electrical energy.

The parking brake unit 600 may be a device that prevents the vehicle from moving while parked. The parking brake unit 600 may be an electronic parking brake (EPB).

The controller 300 may generate braking force by controlling the regenerative braking unit 400, the main braking unit 500, and the parking brake unit 600 based on internal driving data received from the first receiving unit and external driving data received from the second receiving unit 200.

The controller 300 may determine a braking method to generate braking force based on the internal driving data received from the first receiving unit 100 and the external driving data received from the second receiving unit 200.

The controller 300 may be implemented through a processor (not shown) configured to perform the operations described hereinbelow using a nonvolatile memory (not shown) configured to store an algorithm, which, when executed by the processor, provides control operations of various components of the vehicle or data regarding software instructions reproducing the algorithm and data stored in the corresponding memory.

Here, the memory and the processor may be implemented as individual chips. Alternatively, the memory and the processor may be implemented as a single chip in which the memory and the processor are integrated with each other. The processor may have the form of one or more processors.

The components of the braking control apparatus may communicate via wireless or wired connections to exchange information. For example, the components of the braking control apparatus may exchange data using communications units, such as Ethernet, media oriented systems transport (MOST), flexray, controller area network (CAN), local interconnect network (LIN), Internet, LTE, 5G, Wi-Fi, Bluetooth, NFC, ZigBee®, and RF.

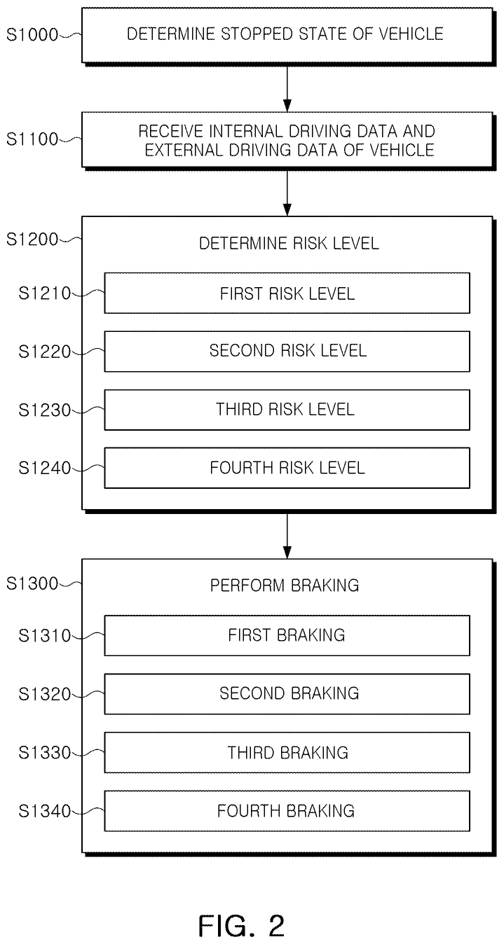

FIG. 2 is a block diagram of a braking control method according to an embodiment of the present disclosure.

Referring to FIG. 2, the braking control method according to an embodiment of the present disclosure may include an operation of determining a stopped state of the vehicle (S1000).

The present disclosure aims at preventing accidents by generating braking force in cases in which unintended acceleration occurs due to driver's carelessness or the like, and whether the vehicle is stopped may be determined.

If a driving speed of the vehicle received through the first receiving unit 100 is ‘0,’ the controller 300 may determine that the vehicle is in a stopped state.

The braking control method according to an embodiment of the present disclosure may receive internal driving data and external driving data of the vehicle (S1100).

Here, the controller 300 may receive the internal driving data of the vehicle through the first receiving unit 100 and the external driving data of the vehicle through the second receiving unit 200.

In addition, the internal driving data of the vehicle may include at least one of a driving speed of the vehicle, a steering angle, a transmission status, or torque and output of the driving motor.

In addition, the external driving data of the vehicle may include information on whether an obstacle is present in a driving direction of the vehicle, a relative distance between the vehicle and a front obstacle, or location information of the front obstacle detected through one of radar, LIDAR, camera, ultrasonic sensor, and infrared sensor.

In addition, the external driving data of the vehicle may include information on traffic signals, road conditions, and ongoing construction work received using traffic infrastructure and V2I communications.

In addition, the external driving data of the vehicle may include information on adjacent vehicles and blind spot information received using V2V communications.

In addition, the external driving data of the vehicle may include information on whether a road on which the vehicle is driving, which is received through GPS, is a child protection zone, a two-lane road, or an alley.

The controller 300 may determine a risk level due to unintended acceleration of the driver due to driver inattention or the like, based on the internal driving data received from the first receiving unit 100 and the external driving data received from the second receiving unit 200 (S1200).

The controller 300 may determine the risk level due to the unintended acceleration of the driver due to driver's carelessness or the like into a first risk level (S1210), a second risk level (S1220), a third risk level (S1230), and a fourth risk level (S1240).

Based on the output of the driving motor received through the first receiving unit 100, the controller 300 may determine the risk level due to the unintended acceleration of the driver due to driver's carelessness or the like into the first risk level (S1210), the second risk level (S1220), the third risk level (S1230), and the fourth risk level (S1240).

The controller 300 may previously set and store a first reference output and a second reference output for the output of the driving motor. In addition, the second reference output may be greater than the first reference output.

For example, the first reference output may be 70 kW and the second reference output may be 110 kW. However, the present disclosure is not limited thereto, and the first reference output and the second reference output may be set to vary depending on the type of vehicle, type of driving motor, and the like.

When the output of the driving motor is less than the first reference output, the controller 300 may determine the risk level to be one of the first risk level and the second risk level.

Here, the controller 300 may determine one of the first risk level and the second risk level based on the external driving data received through the second receiving unit 200.

More specifically, in a case in which the output of the driving motor is less than the first reference output, the controller 300 may determine the risk level as the first risk level if the road on which the driver is driving is not a two-lane road and there are no obstacles in the driving direction.

In addition, in a case in which the output of the driving motor is less than the first reference output, the controller 300 may determine the risk level as the second risk level if the road on which the driver is driving is a two-lane road, a child protection zone, an alley, or there is an obstacle in the driving direction.

The controller 300 may determine the risk level as the third risk level if the output of the driving motor is greater than the first reference output and less than the second reference output.

In addition, the controller 300 may determine the risk level as the fourth risk level if the output of the driving motor is greater than the second reference output.

The controller 300 may perform braking of the vehicle according to the risk level (S1300).

The controller 300 may include first braking (S1310), second braking (S1320), third braking (S1330), and fourth braking (S1340).

The controller 300 may perform the first braking (S1310) at the first risk level (S1210), the second braking (S1320) at the second risk level (S1220), the third braking

(S1330) at the third risk level (S1230), and the fourth braking (S1340) at the fourth risk level (S1240).

In the first braking (S1310), the controller 300 may generate braking force using the regenerative braking unit 400.

In the second braking (S1320), the controller 300 may generate braking force using the regenerative braking unit 400 and the parking brake unit 600.

In the third braking (S1330), the controller 300 may generate braking force using the regenerative braking unit 400, the parking brake unit 600, and the main braking unit 500.

In the fourth braking (S1340), the controller 300 may generate braking force using the regenerative braking unit 400, the parking brake unit 600, and the main braking unit 500 and stop the vehicle as quickly as possible by stopping the operation of the driving motor.

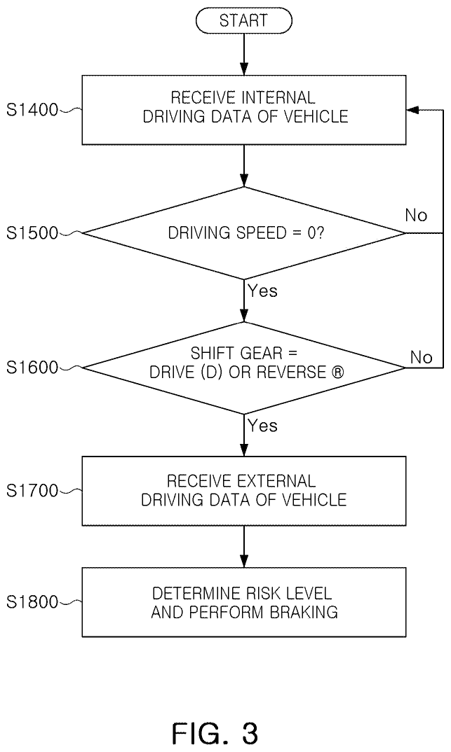

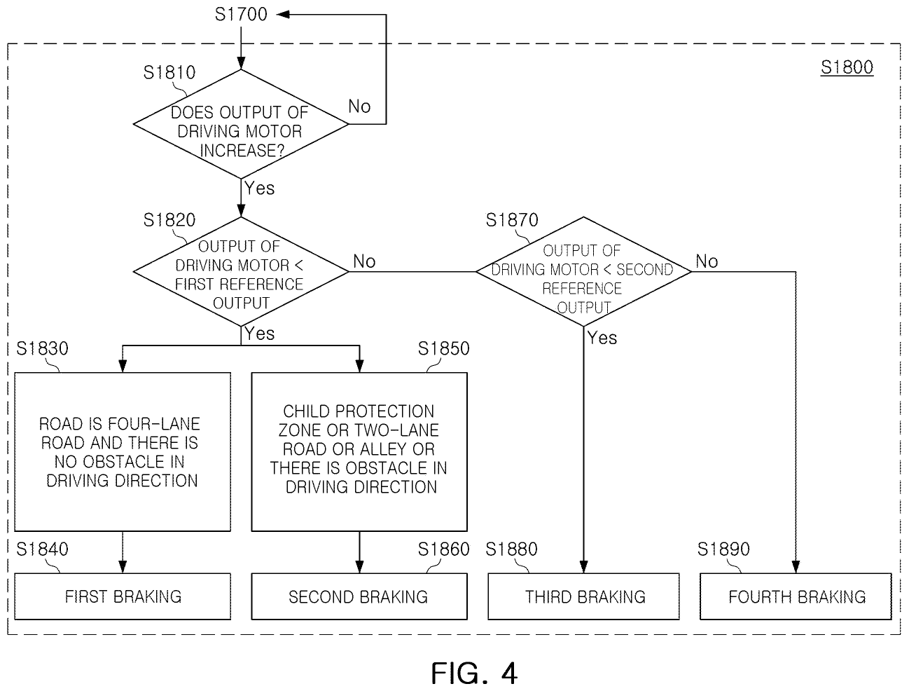

FIG. 3 is a flowchart of a braking control method according to an embodiment of the present disclosure, and FIG. 4 is a detailed flowchart of S1700 of FIG. 3.

Referring to FIG. 3, the controller 300 may receive the internal driving data of the vehicle through the first receiving unit 100 (S1400).

Here, the internal driving data of the vehicle may include at least one of a driving speed of the vehicle, a steering angle, a transmission status, or torque and output of the driving motor.

The controller 300 may determine whether the received driving speed of the vehicle is ‘0’ (S1500). The present disclosure aims at preventing accidents by generating braking force in cases in which unintended acceleration occurs due to driver's carelessness or the like in a vehicle in a stopped state. If the vehicle is not in a stopped state, operation S1400 may be performed again, and the internal driving data of the vehicle may be received and checked.

When the driving speed of the vehicle is ‘0,’ the controller 300 may check a gear shift status of the vehicle received through the first receiving unit 100 (S1600).

More specifically, the controller 300 may determine whether the gear shift status of the vehicle is Drive (D) or Reverse (R).

If the gear shift status is Drive (D) or Reverse (R), the driving motor of the vehicle may generate output and there is a risk of unintended acceleration due to the driver's inexperience in operation.

When the driving speed of the vehicle is ‘0’ and the gear shift status is Drive (D) or Reverse (R), the controller 300 may receive the external driving data of the vehicle through the second receiving unit 200 (S1700).

The external driving data of the vehicle may include information on whether an obstacle is present in a driving direction of the vehicle, a relative distance between the vehicle and a front obstacle, or location information of the front obstacle detected through one of radar, LIDAR, camera, ultrasonic sensor, and infrared sensor provided in the vehicle.

In addition, the external driving data of the vehicle may include a detailed driving map and driving route information received through GPS and may include information on whether a road on which the vehicle is driving is a child protection zone, a two-lane road, or an alley.

In addition, the external driving data of the vehicle may include information on traffic signals, road conditions, and ongoing construction work received using traffic infrastructure and V2I communications.

In addition, the external driving data of the vehicle may include information on adjacent vehicles and blind spot information received using V2V communications.

The controller 300 may determine a risk level based on the internal driving data and external driving data of the vehicle and generate braking force accordingly to brake the vehicle (S1800).

Operation S1800 will be described in more detail with reference to FIG. 4.

The controller 300 may determine whether the output of the driving motor received through the first receiving unit 100 is increasing (S1810).

In a case in which the output of the driving motor does not increase, the controller 300 may return to operation S1700 and update the external driving data.

However, without being limited thereto, and in a case in which the output of the driving motor does not increase, the controller 300 may return to operation S1400 and update the internal driving data.

When the output of the driving motor is increasing, the controller 300 may compare a current driving motor output received from the first receiving unit 100 with a preset first reference output (S1820).

In a case in which the output of the driving motor is less than the first reference output, the controller 300 may check external driving data.

In a case in which the output of the driving motor is less than the first reference output, the controller 300 may determine the risk level to be the first risk level if the road on which the driver is driving is not a two-lane road and no obstacle in front of the vehicle is detected (S1830).

Since the first risk level is a relatively safe state where the output of the driving motor is relatively small, if the risk level is determined to be the first risk level, the controller 300 performs first braking to generate braking force using only the regenerative braking unit 400 (S1840).

In addition, even if the output of the driving motor is less than the first reference output, the controller 300 may determine the risk level to be the second risk level if the road on which the vehicle is driving is a child protection zone, a two-lane road, an alley or when an obstacle is detected in the driving direction (S1850).

Since the second risk level is a state in which the output of the driving motor is relatively small but the risk of an accident that may occur in the road is relatively high compared to the first risk level, and thus, the controller 300 may perform second braking to generate braking force using the parking brake unit 600 in addition to the regenerative braking unit 400 (S1860).

In addition, when the output of the driving motor is greater than the first reference output, the controller 300 may compare the output of the driving motor with the second reference output (S1870).

In a case in which the output of the driving motor is less than the second reference output, the controller 300 may determine the risk level to be the third risk level.

Since the output of the driving motor is relatively large in the third risk level, the risk of an accident is greater than that of the second risk level, and thus, the controller 300 may perform third braking to generate braking force using the regenerative braking unit 400, the parking brake unit 600, and the main braking unit (S1880).

When the output of the driving motor is greater than the second reference output, the controller 300 may determine the risk level to be the fourth risk level.

The fourth risk level has a greater risk of accidents compared to other risk levels due to the relatively large output of the driving motor, and thus, the controller 300 may generate braking force using the regenerative braking unit 400, the parking brake unit 600, and the main braking unit 500 and may perform fourth braking to stop the driving motor (S1890).

In the braking control apparatus and braking control method according to an embodiment of the present disclosure, the risk level of unintended acceleration of the driver due to the driver's inexperience and the like may be determined based on the internal driving data and external driving data of the vehicle, and braking force is generated according to the risk level, thereby improving the driving stability of the vehicle.

The braking control apparatus and braking control method according to an embodiment of the present disclosure may improve the driving safety of the vehicle and prevent traffic accidents by controlling the braking of the vehicle in which unintended acceleration of the driver occurs due to inexperience in operation, etc.

The embodiments of the present disclosure may be implemented as program instructions executable by a variety of computers and recorded on a computer readable medium. The computer readable medium may include a program instruction, a data file, a data structure, or a combination thereof. The program instructions: recorded on the computer readable medium may be designed and configured specifically for the present disclosure or may be publicly known and available to those who are skilled in the field of computer software.

Examples of the computer readable medium may include a hardware device, such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device may be configured to operate as at least one software module in order to perform the embodiments of the present disclosure, and vice versa.

While example embodiments have been illustrated and described above, it will be apparent to those skilled in the art that modifications and variations could be made without departing from the scope of the present disclosure as defined by the appended claims.

What is claimed is:

1. A braking control apparatus comprising:
a first receiving unit detecting internal driving data of a vehicle;
a second receiving unit detecting external driving data of the vehicle;
a regenerative braking unit generating regenerative braking force;
a main braking unit generating braking force in the vehicle;
a parking brake unit generating parking brake force in the vehicle; and
a controller generating braking force by controlling at least one of the regenerative braking unit, the main braking unit, or the parking brake unit based on the internal driving data and the external driving data in response to determining that unintended acceleration occurs.

2. The braking control apparatus of claim 1, wherein the internal driving data includes at least one of a driving speed of the vehicle, a transmission status, or an output of a driving motor.

3. The braking control apparatus of claim 1, wherein the external driving data includes at least one of whether an obstacle is present in a driving direction of the vehicle, a relative distance between the vehicle and an obstacle in front of the vehicle, location information of the obstacle in front of the vehicle, a traffic signal, a road condition, ongoing construction work, information on adjacent vehicles, whether a road on which the vehicle is driving is a child protection zone, whether the road is a two-lane road, or whether the road is an alley.

4. The braking control apparatus of claim 1, wherein
the internal driving data includes output of a driving motor, and
the controller compares the output of the driving motor with a preset first reference output or a preset second reference output and generates braking force by controlling at least one of the regenerative braking unit, the main braking unit, or the parking brake unit.

5. The braking control apparatus of claim 4, wherein the first reference output is set to be less than the second reference output.

6. The braking control apparatus of claim 4, wherein,
in response to the output of the driving motor being less than the first reference output,
the controller generates braking force by controlling the regenerative braking unit or the parking brake unit.

7. The braking control apparatus of claim 4, wherein,
in response to the output of the driving motor being greater than the first reference output and less than the second reference output,
the controller generates braking force by controlling the regenerative braking unit, the parking brake unit, and the main braking unit.

8. The braking control apparatus of claim 4, wherein,
in response to the output of the driving motor being greater than the second reference output,
the controller generates braking force by controlling the regenerative braking unit, the parking brake unit, and the main braking unit and stops the driving motor.

9. The braking control apparatus of claim 1, wherein
the internal driving data includes a driving speed and a gear shift status, and
in response to the driving speed being ‘0 (zero)’ and the gear shift status being a state in which a gear shift is in a driving state or a reverse state,
the controller generates braking force by controlling at least one of the regenerative braking unit, the main braking unit, or the parking brake unit based on the internal driving data and the external driving data.

10. A braking control method comprising:
receiving internal driving data of a vehicle;
receiving external driving data of the vehicle; and
in response to determining that unintended acceleration occurs, determining a risk level of the vehicle based on the internal driving data and the external driving data and performing braking based on the risk level.

11. The braking control method of claim 10, wherein
the internal driving data of the vehicle includes a driving speed and gear shift status information, and
the receiving of the internal driving data of the vehicle includes determining the received driving speed and the gear shift status.

12. The braking control method of claim 11, wherein the determining of the driving speed and the gear shift status includes determining whether the driving speed is ‘0 (zero)’ and whether the gear shift is in a driving state or a reverse state.

13. The braking control method of claim 10, wherein
the external driving data includes at least one of whether an obstacle is present in a driving direction of the vehicle, a relative distance between the vehicle and an obstacle in front of the vehicle, location information of the obstacle in front of the vehicle, a traffic signal, a road condition, ongoing construction work, information on adjacent vehicles, whether a road on which the vehicle is driving is a child protection zone, whether the road is a two-lane road, or whether the road is an alley.

14. The braking control method of claim 11, wherein
the internal driving data further includes output of a driving motor, and
the determining of the risk level of the vehicle and performing the braking based on the risk level includes:
determining whether the output of the driving motor increases.

15. The braking control method of claim 14, wherein,
in response to determining that the output of the driving motor increases,
the determining of the risk level of the vehicle and performing the braking based on the risk level further includes
comparing the output of the driving motor with a preset first reference output or a preset second reference output, and
the first reference output is less than the second reference output.

16. The braking control method of claim 15, wherein,
in response to the output of the driving motor being less than the first reference output,
in the determining of the risk level of the vehicle and performing the braking based on the risk level, braking force is generated by controlling a regenerative braking unit generating regenerative braking force or a parking brake unit generating parking brake force in the vehicle.

17. The braking control method of claim 15, wherein,
in response to the output of the driving motor being greater than the first reference output and less than the second reference output,
in the determining of the risk level of the vehicle and performing the braking based on the risk level, braking force is generated by controlling a regenerative braking unit generating regenerative braking force, a parking brake unit generating parking brake force in the vehicle, and a main braking unit generating braking force in the vehicle.

18. The braking control method of claim 15, wherein,
in response to the output of the driving motor being greater than the second reference output,
in the determining of the risk level of the vehicle and performing the braking based on the risk level, braking force is generated by controlling a regenerative braking unit generating regenerative braking force, a parking brake unit generating parking brake force in the vehicle, and a main braking unit generating braking force in the vehicle, and the driving motor is stopped.

19. The braking control method of claim 16, wherein
the external driving data includes at least one of information on whether an obstacle is present in the driving direction of the vehicle, whether the road is a two-lane road, or whether the road on which the vehicle is driving is a child protection zone, and
in the determining of the risk level of the vehicle and performing the braking based on the risk level, braking force is generated by controlling the regenerative braking unit and the parking brake unit in response to determining that an obstacle is present in the driving direction of the vehicle, the road is a two-lane road, and the road on which the vehicle is driving is a child protection zone.

20. The braking control method of claim 16, wherein
the external driving data includes at least one of information on whether an obstacle is present in the driving direction of the vehicle, whether the road is a two-lane road, or whether the road on which the vehicle is driving is a child protection zone, and
in the determining of the risk level of the vehicle and performing the braking based on the risk level, braking force is generated by controlling the regenerative braking unit in response to determining that no obstacle is present in the driving direction of the vehicle, the road is a four-lane road, and the road on which the vehicle is driving is not a child protection zone.
